(19) United States
(12) Patent Application Publication
(10) Pub. No.: US 2026/0106081 A1
(43) Pub. Date: Apr. 16, 2026

(54) ELECTRONIC COMPONENT

(71) Applicant: TDK Corporation, Tokyo (JP)

(72) Inventors: Ken MORITA, Tokyo (JP); Atsushi TAKEDA, Tokyo (JP); Shinya ONODERA, Tokyo (JP); Yuichi NAGAI, Tokyo (JP); Yugo KANAMOTO, Tokyo (JP)

(73) Assignee: TDK Corporation, Tokyo (JP)

(21) Appl. No.: 19/279,763

(22) Filed: Jul. 24, 2025

(30) Foreign Application Priority Data
Oct. 11, 2024 (JP) 2024-178937

(51) Int. Cl. H01G 4/232; H01G 4/30

(52) U.S. Cl. CPC H01G 4/2325; H01G 4/30

(57) ABSTRACT

An electronic component includes an element body and an external electrode disposed on the element body. The external electrode includes a conductive resin layer and a plating layer disposed on the conductive resin layer. The conductive resin layer includes a plurality of electrically conductive particles and a resin. The plurality of electrically conductive particles includes a plurality of first electrically conductive particles and a plurality of second electrically conductive particles. The first electrically conductive particle includes a core that is less prone to migration than silver and a film that covers the core and includes silver. The second electrically conductive particle includes silver. The plating layer is separated from the element body by a gap.

### CROSS-REFERENCE TO RELATED APPLICATIONS

This application is based upon and claims the benefit of priority from Japanese Patent Application No. 2024-178937, filed on Oct. 11, 2024, the entire contents of which are incorporated herein by reference.

### BACKGROUND

### Field

The present disclosure relates to an electronic component.

### Description of the Related Art

Known electronic components include an element body and an external electrode disposed on the element body (see, for example, Japanese Unexamined Patent Publication No. H11-162771). The external electrode includes a conductive resin layer including a plurality of electrically conductive particles and a resin and a plating layer disposed on the conductive resin layer. The plurality of electrically conductive particles are made of silver (Ag).

### SUMMARY

In a configuration in which the electrically conductive particles are made of silver, silver migration may occur in the external electrode. The silver migration is considered to occur due to the following events, for example.

An electric field or heat acts on the electrically conductive particle, causing ionization of the silver. The silver may be ionized under influence of oxygen. Generated silver ion is attracted by an electric field between the external electrodes and migrates from the conductive resin layer. For example, the electric field acting on the silver includes an electric field between the external electrodes or an electric field between the external electrode and an internal conductor in the element body. For example, the silver ion migrating from the conductive resin layer reacts with an electron supplied from the internal conductor or the external electrode, and is deposited as silver on a surface of the element body.

An object of one aspect of the present disclosure is to provides an electronic component that suppresses progression of silver migration.

An electronic component according to one aspect of the present disclosure includes an element body and an external electrode disposed on the element body. The external electrode includes: a conductive resin layer that includes a plurality of electrically conductive particles and a resin; and a plating layer that is disposed on the conductive resin layer. The plurality of electrically conductive particles includes: a plurality of first electrically conductive particles each including a core that is less prone to migration than silver and a film that covers the core and includes silver; and a plurality of second electrically conductive particles including silver. The plating layer is separated from the element body by a gap.

In the one aspect, the first electrically conductive particle includes the core that is less prone to migration than silver. The first electrically conductive particle has a lower silver content than the electrically conductive particle made of silver and having the same size as the first electrically conductive particle. The conductive resin layer including the plurality of first electrically conductive particles and the plurality of second electrically conductive particles tends to have a lower silver content than the conductive resin layer including only the plurality of second electrically conductive particles, i.e., the conductive resin layer not including the first electrically conductive particles. Even in environments where silver migration may occur, a configuration with a low silver content reduces the rate at which silver migration progresses. Therefore, this aspect suppresses the progression of silver migration.

The resin tends to absorb moisture. When the electronic component is solder-mounted on an electronic device, the moisture absorbed by the resin may be gasified so that volume expansion may occur. In this case, stress may act on the conductive resin layer, and as a result, the conductive resin layer may peel off. For example, the electronic device includes a circuit board or an electronic component.

In the one aspect, even if moisture absorbed by the resin is gasified when the electronic component is solder-mounted, a gas generated from the moisture moves to the outside of the external electrode through the gap between the plating layer and the element body. Therefore, stress tends not to act on the conductive resin layer. Consequently, this aspect suppresses the peeling off of the conductive resin layer.

In the one aspect, the conductive resin layer may include a first region including an end edge of the conductive resin layer and a second region away from the first region. A ratio of the first electrically conductive particles to a total of the first electrically conductive particles and the second electrically conductive particles in the first region may be larger than a ratio of the first electrically conductive particles to the total of the first electrically conductive particles and the second electrically conductive particles in the second region.

Silver ion tends to migrate from the end edge of the conductive resin layer. In a configuration in which the first region including the end edge of the conductive resin layer has the above-described “ratio of the first electrically conductive particles” that is larger than the above-described “ratio of the first electrically conductive particles” of the second region, the first region tends to have a low silver content. This configuration reliably reduces the rate at which the silver migration progresses. Therefore, this configuration reliably suppresses the progression of silver migration.

The second region has the above-described “ratio of the first electrically conductive particles” that is smaller than the above-described “ratio of the first electrically conductive particles” of the first region. Therefore, the second region tends to have a high silver content. Silver has a high electrical conductivity. The second region reliably maintains electrical conductivity in the conductive resin layer. This configuration suppresses an increase in ESR (equivalent series resistance) of the electronic component.

In the one aspect, the element body may include an end surface and a side surface adjacent to each other. The conductive resin layer may be disposed on both the end surface and the side surface. The first region may be positioned on the side surface, and the second region may be positioned on the end surface.

In the electronic component, for example, an internal conductor tends to be exposed at the end surface. A configuration in which the second region is positioned on the end surface reliably maintains electrical conductivity in the portion of the conductive resin layer positioned on the end surface. Therefore, this configuration reliably suppresses an increase in the ESR of the electronic component.

In the one aspect, the element body may include an end surface and a side surface adjacent to each other. The conductive resin layer may be disposed on the side surface. With a plane including the end surface as a reference plane, the second region may be positioned closer to the reference plane than the first region.

In the electronic component, for example, an internal conductor tends to be exposed at the end surface. A configuration in which the second region is positioned closer to the reference plane than the first region reliably maintains electrical conductivity in the vicinity of the portion of the conductive resin layer positioned on the end surface. Therefore, this configuration can reliably suppress an increase in the ESR of the electronic component.

In the one aspect, the external electrode may include a sintered metal layer that is disposed between the element body and the conductive resin layer and is covered with the conductive resin layer. The first region may be positioned directly on the element body, and the second region may be positioned directly on the sintered metal layer.

A configuration in which the second region is positioned directly on the sintered metal layer tends to reduce electrical resistance in an electrically conductive path between the plating layer and the sintered metal layer. Therefore, this configuration reliably suppresses an increase in the ESR of the electronic component.

In the one aspect, a particle diameter of the first electrically conductive particle may be smaller than a particle diameter of the second electrically conductive particle.

A configuration in which the first electrically conductive particle has the particle diameter that is smaller than the particle diameter of the second electrically conductive particle can increase the content of the first electrically conductive particle in the first region. Therefore, this configuration can further suppress the progression of silver migration.

In the one aspect, the plurality of second electrically conductive particles may include a plurality of flake-shaped second electrically conductive particles.

A configuration in which the plurality of second electrically conductive particles include the plurality of flake-shaped second electrically conductive particles further suppresses an increase in the ESR of the electronic component.

In the one aspect, the conductive resin layer may include a region including an end edge of the conductive resin layer. In the region of the conductive resin layer, a ratio of the first electrically conductive particles to a total of the first electrically conductive particles and the flake-shaped second electrically conductive particles may be larger than a ratio of the flake-shaped second electrically conductive particles to a total of the first electrically conductive particles and the flake-shaped second electrically conductive particles. A configuration in which the above-described “ratio of the first electrically conductive particles” is larger than the above-described “ratio of the flake-shaped second electrically conductive particles” in the region can increase the content of the first electrically conductive particle in the region. Therefore, this configuration can further suppress the progression of silver migration.

In the one aspect, the plurality of second electrically conductive particles may include a plurality of spherical-shaped second electrically conductive particles.

A configuration in which the plurality of second electrically conductive particles includes the plurality of spherical-shaped second electrically conductive particles can increase the content of the second electrically conductive particle in the second region. Therefore, this configuration can reliably suppress an increase in the ESR of the electronic component.

In the one aspect, a particle diameter of the spherical-shaped second electrically conductive particle may be smaller than a particle diameter of the flake-shaped second electrically conductive particle, and a particle diameter of the first electrically conductive particle may be smaller than a particle diameter of the spherical-shaped second electrically conductive particle.

A configuration in which the first electrically conductive particle has the particle diameter that is smaller than the particle diameters of both the flake-shaped second electrically conductive particle and the spherical-shaped second electrically conductive particle can increase the content of the first electrically conductive particle in the first region. Therefore, this configuration can further suppress the progression of silver migration.

A configuration in which the particle diameter of the spherical-shaped second electrically conductive particle is smaller than the particle diameter of the flake-shaped second electrically conductive particle can increase the content of the second electrically conductive particle in the second region. Therefore, this configuration can reliably suppress an increase in the ESR of the electronic component.

In the one aspect, a width of the gap may be smaller than a particle diameter of the first electrically conductive particle.

A configuration in which the width of the gap between the plating layer and the element body is smaller than the particle diameter of the first electrically conductive particle suppresses the progression of silver migration from the end edge of the conductive resin layer. Therefore, this configuration further suppresses the progression of silver migration.

In the one aspect, the core may include a resin.

The resin tends not to oxidize. Therefore, a configuration in which the core includes the resin suppresses deterioration of characteristics of the first electrically conductive particle. For example, the characteristics of the first electrically conductive particle include electrical conductivity or heat resistance.

### BRIEF DESCRIPTION OF THE DRAWINGS

FIG. 1 is a perspective view of a multilayer capacitor according to an example;

FIG. 2 is a view illustrating a cross-sectional configuration of the multilayer capacitor according to the example;

FIG. 3 is a view illustrating a cross-sectional configuration of the multilayer capacitor according to the example;

FIG. 4 is a view illustrating a second electrode layer;

FIG. 5 is a view illustrating a cross-sectional configuration of the second electrode layer;

FIG. 6 is a view illustrating a cross-sectional configuration of the second electrode layer;

FIG. 7 is a view illustrating a cross-sectional configuration of the second electrode layer;

FIG. 8 is view illustrating a configuration of an electrically conductive particle;

FIG. 9 is a perspective view of a multilayer capacitor according to a modification of the example;

FIG. 10 is a view illustrating a cross-sectional configuration of the multilayer capacitor according to the modification of the example; and

FIG. 11 is a view illustrating a second electrode layer.

### DETAILED DESCRIPTION

In the following description, with reference to the drawings, the same reference numbers are assigned to the same components or to similar components having the same function, and overlapping description is omitted.

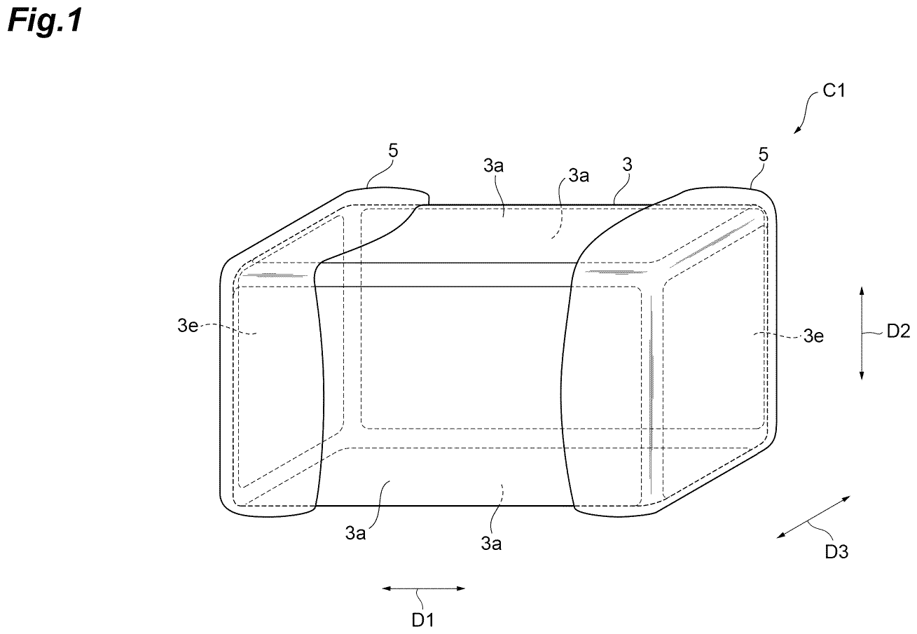

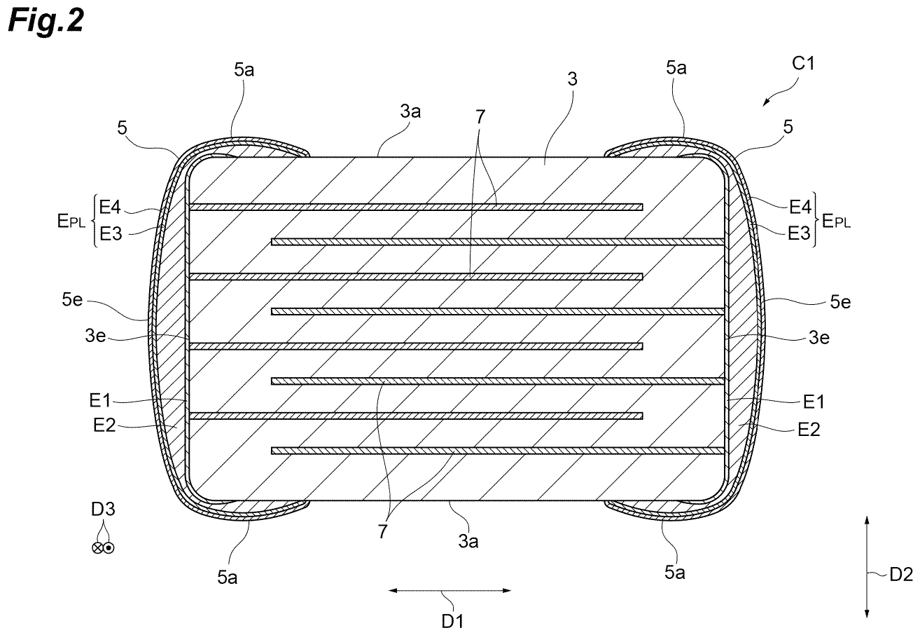

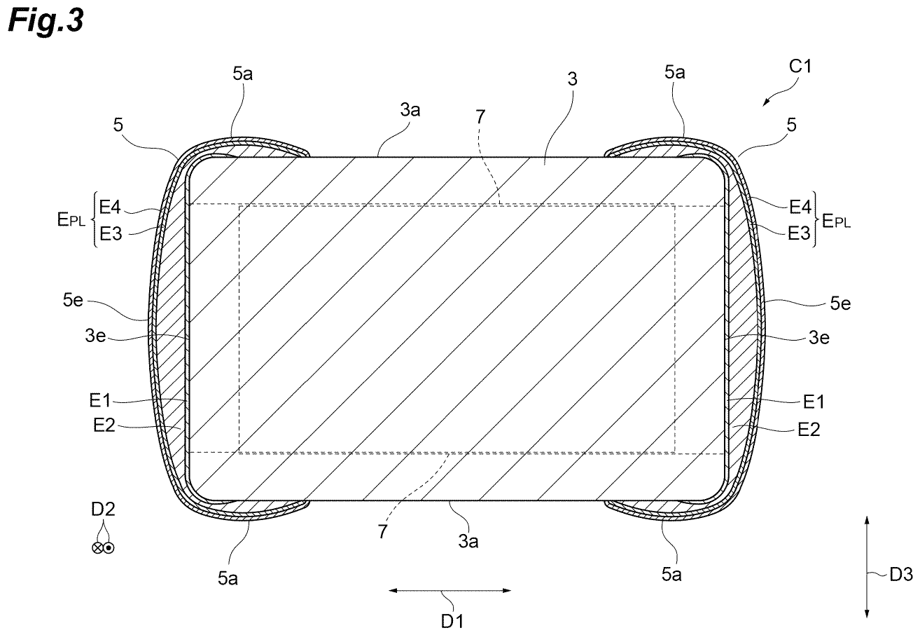

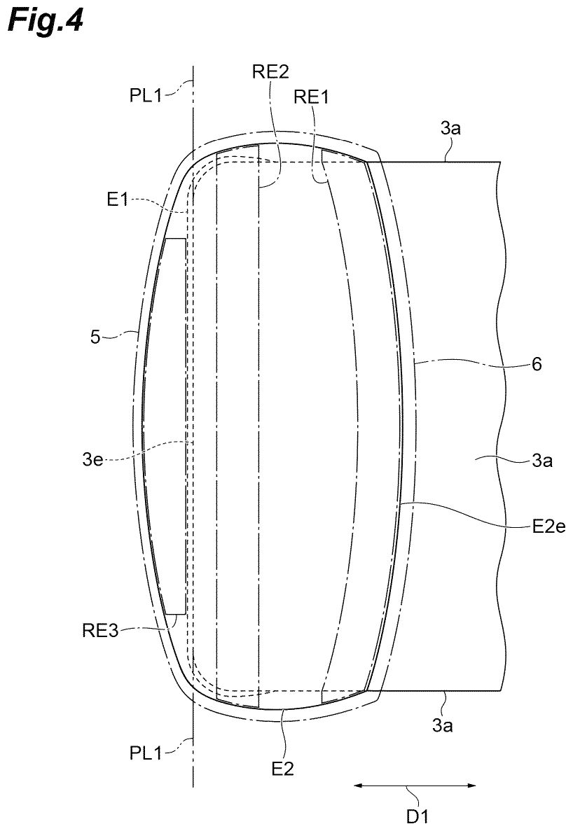

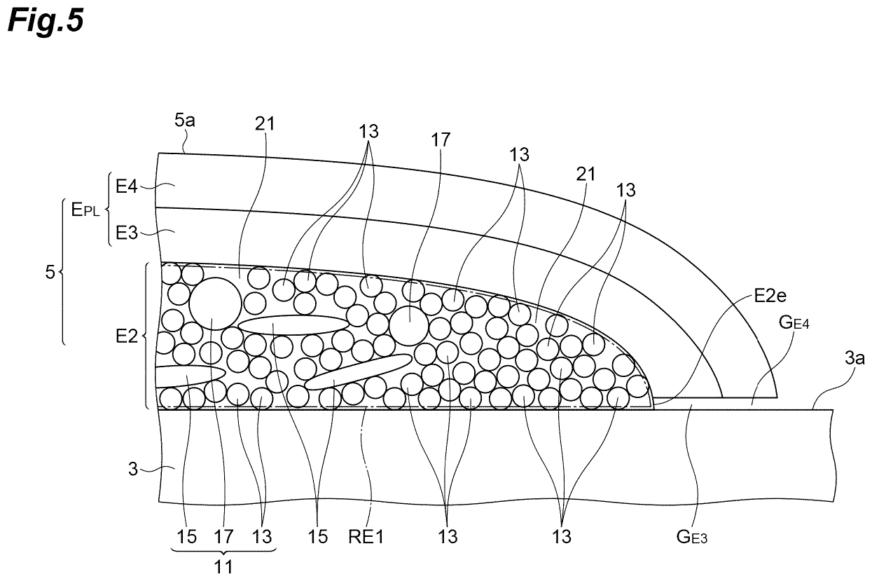

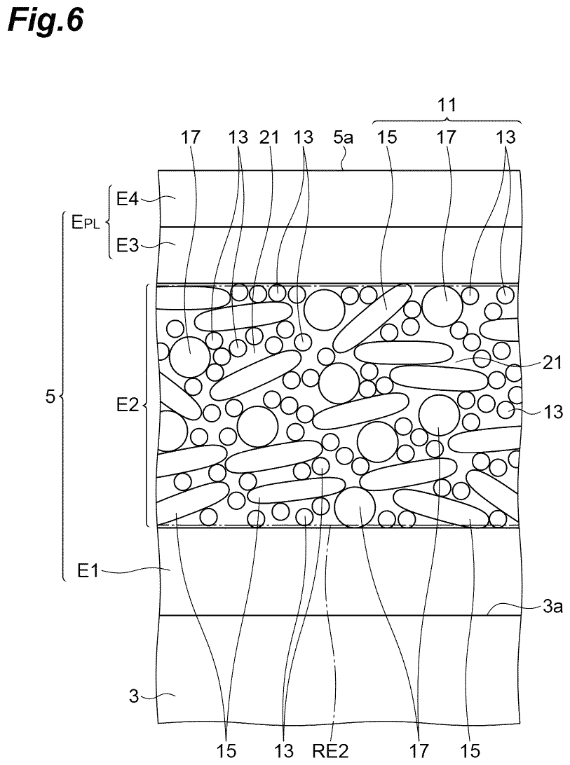

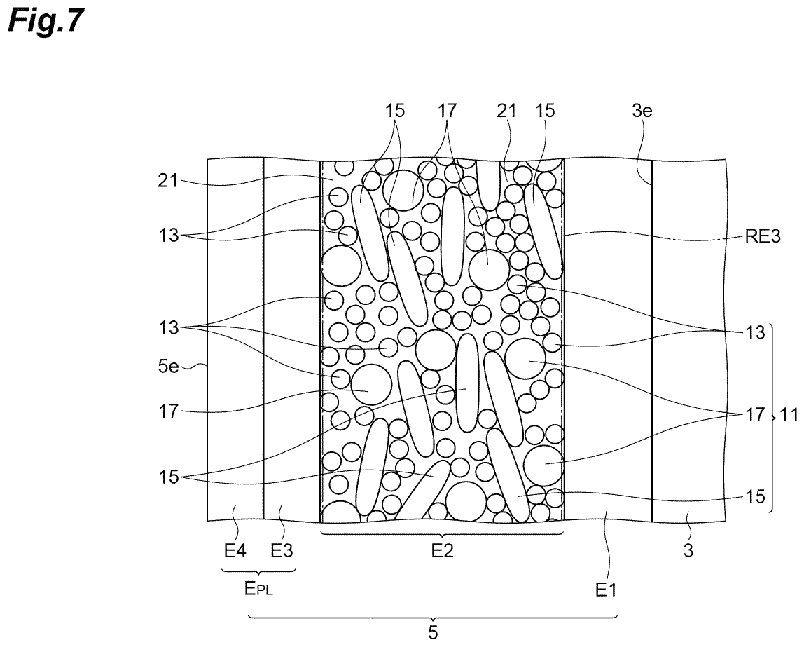

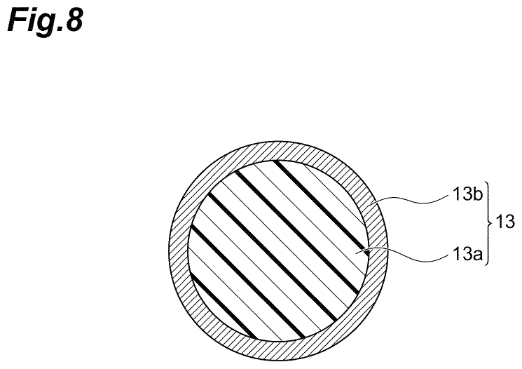

A configuration of a multilayer capacitor C1 according to the example will be described with reference to FIGS. 1 to 8. FIG. 1 is a perspective view of a multilayer capacitor according to the example. FIGS. 2 and 3 are views illustrating a cross-sectional configuration of the multilayer capacitor according to the example. FIG. 4 is a view illustrating a second electrode layer. FIGS. 5, 6, and 7 are views illustrating a cross-sectional configuration of the second electrode layer. FIG. 8 is view illustrating a configuration of an electrically conductive particle.

For example, an electronic component includes the multilayer capacitor C1.

As illustrated in FIG. 1, the multilayer capacitor C1 includes an element body 3 of a rectangular parallelepiped shape and a plurality of external electrodes 5. For example, the multilayer capacitor C1 includes a pair of external electrodes 5. The pair of external electrodes 5 are disposed on an outer surface of the element body 3. The pair of external electrodes 5 are separated from each other. The rectangular parallelepiped shape includes a rectangular parallelepiped shape in which corners and ridges are chamfered, or a rectangular parallelepiped shape in which the corners and ridges are rounded.

The element body 3 includes four side surfaces 3a and a pair of end surfaces 3e opposing each other. The four side surfaces 3a and the pair of end surfaces 3e each have a substantially rectangular shape. The four side surfaces 3a include a first pair of side surfaces 3a opposing each other and a second pair of side surfaces 3a opposing each other. A direction in which the first pair of side surfaces 3a oppose each other includes a direction D2. A direction in which the second pair of side surfaces 3a oppose each other includes a direction D3. A direction in which the pair of end surfaces 3e oppose each other includes a direction D1.

The multilayer capacitor C1 is solder-mounted on an electronic device, for example. For example, the electronic device includes a circuit board or an electronic component. In the multilayer capacitor C1, for example, one of the four side surfaces 3a opposes the electronic device. The one of the four side surfaces 3a is arranged to constitute a mounting surface. The one of the four side surfaces 3a includes the mounting surface.

The direction D2 includes a direction perpendicular to the first pair of side surfaces 3a, and is perpendicular to the direction D3. The direction D1 includes a direction parallel to the four side surfaces 3a, and is perpendicular to the direction D2 and the direction D3. The direction D3 includes a direction perpendicular to the second pair of side surfaces 3a, and the direction D1 includes a direction perpendicular to the end surfaces 3e. For example, a length of the element body 3 in the direction D1 is larger than a length of the element body 3 in the direction D2 and larger than a length of the element body 3 in the direction D3. The direction D1 includes a longitudinal direction of the element body 3. The length of the element body 3 in the direction D2 and the length of the element body 3 in the direction D3 may be equal to each other. The length of the element body 3 in the direction D2 and the length of the element body 3 in the direction D3 may be different from each other.

For example, the length of the element body 3 in the direction D2 defines a height of the element body 3. For example, the length of the element body 3 in the direction D3 defines a width of the element body 3. For example, the length of the element body 3 in the direction D1 defines a longitudinal length of the element body 3. For example, the height of the element body 3 ranges from 0.1 to 3.2 mm, the width of the element body 3 ranges from 0.1 to 6.3 mm, and the longitudinal length of the element body 3 ranges from 0.2 to 7.5 mm. For example, the height of the element body 3 is 2.5 mm, the width of the element body 3 is 2.5 mm, and the longitudinal length of the element body 3 is 3.2 mm.

The first pair of side surfaces 3a extend in the direction D3 to couple the second pair of side surfaces 3a to each other. The first pair of side surfaces 3a extends in the direction D1. The second pair of side surfaces 3a extends in the direction D2 to couple the first pair of side surfaces 3a to each other. The second pair of side surfaces 3a extends in the direction D1. The pair of end surfaces 3e extends in the direction D2 to couple the first pair of side surfaces 3a to each other. The pair of end surfaces 3e extends in the direction D3 to couple the second pair of side surfaces 3a to each other.

The element body 3 includes a ridge portion between the end surface 3e and the side surface 3a and a ridge portion between one of the first pair of side surfaces 3a and one of the second pair of side surfaces 3a. For example, the ridge portions are rounded to be curved. For example, the element body 3 is subjected to what is called a round chamfering process. The end surface 3e and the side surface 3a are indirectly adjacent to each other with the ridge portion between the end surface 3e and the side surface 3a. The one of the first pair of side surfaces 3a and the one of the second pair of side surfaces 3a are indirectly adjacent to each other with the ridge portion between the one of the first pair of side surfaces 3a and the one of the second pair of side surfaces 3a.

The element body 3 is configured through laminating a plurality of dielectric layers in the direction D2. The element body 3 includes a plurality of laminated dielectric layers. In the element body 3, a lamination direction of the plurality of dielectric layers coincides with the direction D2. For example, each dielectric layer includes a sintered body of a ceramic green sheet containing a dielectric material. Examples of the dielectric material include dielectric ceramics. Examples of the dielectric ceramics include BaTiO₃-based, Ba(Ti, Zr)O₃-based, or (Ba, Ca)TiO₃-based dielectric ceramics. In the actual element body 3, each of the dielectric layers is integrated to such an extent that a boundary between the dielectric layers cannot be visually recognized.

As illustrated in FIGS. 2 and 3, the multilayer capacitor C1 includes a plurality of internal electrodes 7. Each of the internal electrodes 7 includes an internal conductor disposed in the element body 3. Each of the internal electrodes 7 is made of an electrically conductive material that is commonly used as an internal conductor of a multilayer electronic component. For example, the electrically conductive material includes a base metal. For example, the electrically conductive material includes nickel (Ni) or copper (Cu). Each of the internal electrodes 7 is configured as a sintered body of electrically conductive paste containing the electrically conductive material described above. For example, the internal electrodes 7 include nickel.

The plurality of internal electrodes 7 are disposed in different positions (layers) in the direction D2. The plurality of internal electrodes 7 are disposed in the element body 3 to oppose each other in the direction D2 with an interval therebetween. The internal electrodes 7 adjacent to each other in the direction D2 have different polarities from each other. One end of the internal electrode 7 is exposed at a corresponding end surface 3e of the pair of end surfaces 3e. The internal electrode 7 includes one end exposed at the corresponding end surface 3e. The plurality of internal electrodes 7 include an internal electrode 7 exposed at one end surface 3e of the pair of end surfaces 3e and an internal electrode 7 exposed at the other end surface 3e of the pair of end surfaces 3e. The internal electrodes 7 exposed at the one end surface 3e and the internal electrodes 7 exposed at the other end surface 3e are alternately disposed in the direction D2. The plurality of internal electrodes 7 are disposed in the element body 3 to be distributed in the direction D2. The internal electrode 7 is positioned in a plane substantially parallel to the first pair of side surfaces 3a. A direction in which the internal electrodes 7 oppose each other, that is, the direction D2 is perpendicular to a direction parallel to the first pair of side surfaces 3a. The direction in which the internal electrodes 7 oppose each other is perpendicular to the directions D3 and D1.

In a configuration in which the lamination direction of the plurality of dielectric layers includes the direction D3, the plurality of internal electrodes 7 are disposed in different positions (layers) in the direction D3. In a configuration in which the lamination direction of the plurality of dielectric layers includes the direction D3, the internal electrodes 7 exposed at the one end surface 3e and the internal electrodes 7 exposed at the other end surface 3e are alternately disposed in the direction D3. The internal electrode 7 is positioned in a plane substantially parallel to the second pair of side surfaces 3a. The internal electrodes 7 oppose each other in the direction D3.

As illustrated in FIG. 1, the external electrodes 5 are disposed at both ends of the element body 3 in the first direction D1. Each external electrode 5 is disposed on a corresponding end surface 3e of the pair of end surfaces 3e. For example, each external electrode 5 is disposed on the four side surfaces 3a and the one end surface 3e. The external electrode 5 includes a plurality of electrode portions 5a and 5e, as illustrated in FIGS. 2 and 3. The electrode portion 5a is disposed on both the side surface 3a and the ridge portion between the side surface 3a and the end surface 3e. The electrode portion 5e is disposed on the end surface 3e. The external electrode 5 includes an electrode portion disposed on the ridge portion between the adjacent side surfaces 3a. For example, the ridge portion between the side surface 3a and the end surface 3e is referred to as a first ridge portion, and the ridge portion between the adjacent side surfaces 3a is referred to as a second ridge portion.

Each external electrode 5 is formed on five surfaces of the four side surfaces 3a and the end surface 3e as well as the above-described ridge portions. The electrode portions 5a and 5e adjacent to each other are physically coupled and are electrically connected to each other. The electrode portion 5e covers the entire one end of a corresponding internal electrode 7 of the plurality of internal electrodes 7. The electrode portion 5e is directly connected to the corresponding internal electrode 7. The external electrode 5 is electrically connected to the corresponding internal electrode 7.

As illustrated in FIGS. 2 and 3, the external electrode 5 includes a first electrode layer E1, a second electrode layer E2, a third electrode layer E3, and a fourth electrode layer E4. The fourth electrode layer E4 includes the outermost layer of the external electrode 5. Each of the electrode portions 5a and 5e includes the first electrode layer E1, the second electrode layer E2, the third electrode layer E3, and the fourth electrode layer E4.

The first electrode layer E1 of the electrode portion 5a is disposed on both the first ridge portion and the side surface 3a. In the electrode portion 5a, the first electrode layer E1 may not be disposed on the side surface 3a. The first electrode layer E1 of the electrode portion 5a covers the entire first ridge portion and a partial region of the side surface 3a. The first electrode layer E1 of the electrode portion 5a is in contact with the first ridge portion and the partial region of the side surface 3a. The side surface 3a is exposed from the first electrode layer E1 except for the partial region covered with the first electrode layer E1. The partial region covered with the first electrode layer E1 of the electrode portion 5a is positioned closer to the end surface 3e.

The second electrode layer E2 of the electrode portion 5a is disposed on both the first electrode layer E1 and the side surface 3a. In the electrode portion 5a, the second electrode layer E2 covers the entire first electrode layer E1 and a partial region of the side surface 3a. The second electrode layer E2 of the electrode portion 5a indirectly covers the first ridge portion and the partial region that is covered with the first electrode layer E1, in such a manner that the first electrode layer E1 is positioned between the second electrode layer E2 and the element body 3. In the electrode portion 5a, the second electrode layer E2 is in direct contact with the first electrode layer E1. The partial region covered with the second electrode layer E2 of the electrode portion 5a is positioned closer to the end surface 3e. The side surface 3a is exposed from the second electrode layer E2 in the remaining region excluding the partial region covered with the second electrode layer E2. In the electrode portion 5a, the second electrode layer E2 is in direct contact with the side surface 3a. In the electrode portion 5a, the second electrode layer E2 directly covers the side surface 3a. The second electrode layer E2 of the electrode portion 5a is positioned on both the side surface 3a and the first ridge portion. In the electrode portion 5a, the second electrode layer E2 is positioned directly on both the side surface 3a and the first electrode layer E1.

The third electrode layer E3 of the electrode portion 5a is disposed on the second electrode layer E2. In the electrode portion 5a, the third electrode layer E3 covers the second electrode layer E2. In the electrode portion 5a, the third electrode layer E3 is in contact with the second electrode layer E2. In the electrode portion 5a, the third electrode layer E3 is in direct contact with the second electrode layer E2.

The fourth electrode layer E4 of the electrode portion 5a is disposed on the third electrode layer E3. In the electrode portion 5a, the fourth electrode layer E4 covers the third electrode layer E3. In the electrode portion 5a, the fourth electrode layer E4 is in contact with the third electrode layer E3. In the electrode portion 5a, the fourth electrode layer E4 is in direct contact with the third electrode layer E3. In the electrode portion 5a, the third electrode layer E3 and the fourth electrode layer E4 are not in contact with the side surface 3a. In the electrode portion 5a, the third electrode layer E3 is disposed outside the second electrode layer E2 and is separated from the side surface 3a.

In the electrode portion 5a, the fourth electrode layer E4 is disposed outside the second electrode layer E2 and is separated from the side surface 3a. The fourth electrode layer E4 of the electrode portion 5a is disposed outside the third electrode layer E3 of the electrode portion 5a. The third electrode layer E3 and fourth electrode layer E4 of the electrode portion 5a are positioned on the side surface 3a.

The first electrode layer E1 of the electrode portion 5e is disposed on the end surface 3e. The first electrode layer E1 of the electrode portion 5e covers the entire end surface 3e. The first electrode layer E1 of the electrode portion 5e is in contact with the entire end surface 3e. In the electrode portion 5e, the first electrode layer E1 is in direct contact with the end surface 3e.

The second electrode layer E2 of the electrode portion 5e is disposed on the first electrode layer E1. In the electrode portion 5e, the second electrode layer E2 covers the first electrode layer E1. In the electrode portion 5e, the second electrode layer E2 is in direct contact with the first electrode layer E1. In the electrode portion 5e, the second electrode layer E2 indirectly covers the end surface 3e, in such a manner that the first electrode layer E1 is positioned between the second electrode layer E2 and the end surface 3e. The second electrode layer E2 of the electrode portion 5e is positioned on the end surface 3e. In the electrode portion 5e, the second electrode layer E2 is positioned directly on the first electrode layer E1.

The third electrode layer E3 of the electrode portion 5e is disposed on the second electrode layer E2. In the electrode portion 5e, the third electrode layer E3 covers the second electrode layer E2. In the electrode portion 5e, the third electrode layer E3 is in contact with the second electrode layer E2. In the electrode portion 5e, the third electrode layer E3 is in direct contact with the second electrode layer E2. In the electrode portion 5e, the third electrode layer E3 is not in direct contact with the first electrode layer E1.

The fourth electrode layer E4 of the electrode portion 5e is disposed on the third electrode layer E3. In the electrode portion 5e, the fourth electrode layer E4 covers the third electrode layer E3. In the electrode portion 5e, the fourth electrode layer E4 is in contact with the third electrode layer E3. In the electrode portion 5e, the fourth electrode layer E4 is in direct contact with the third electrode layer E3.

In the electrode portion 5e, the third electrode layer E3 and the fourth electrode layer E4 are disposed outside the second electrode layer E2. The fourth electrode layer E4 of the electrode portion 5e is disposed outside the third electrode layer E3 of the electrode portion 5e. The third electrode layer E3 and fourth electrode layer E4 of the electrode portion 5e are positioned on the end surface 3e.

As illustrated in FIG. 4, the second electrode layer E2 extends along an edge 6 of the external electrode 5 on the side surface 3a when viewed from a direction orthogonal to the side surface 3a. The second electrode layer E2 includes an end edge E2e extending along the edge 6 of the external electrode 5. The second electrode layer E2 includes a plurality of regions RE1, RE2, and RE3. For example, the second electrode layer E2 includes three regions RE1, RE2, and RE3.

The region RE1 includes the end edge E2e. The region RE1 is positioned directly on the element body 3. The region RE1 is positioned directly on the side surface 3a. A width of the region RE1, that is, a length of the region RE1 in the direction D1 is 100 μm or less, for example. The width of the region RE1 is 30 μm, for example.

The region RE2 is separated from the region RE1. For example, the region RE2 is positioned directly on the first electrode layer E1. In a configuration in which the region RE2 is positioned directly on the first electrode layer E1, the region RE2 is positioned indirectly on the element body 3. For example, the region RE2 is positioned indirectly on the side surface 3a. The region RE2 is closer to a reference plane PL1 than the region RE1. The reference plane PL1 is a plane including the end surface 3e. The region RE2 is positioned closer to the end surface 3e than the region RE1.

The region RE3 is separated from the region RE1. For example, the region RE3 is positioned directly on the first electrode layer E1. In a configuration in which the region RE3 is positioned directly on the first electrode layer E1, the region RE3 is positioned indirectly on the element body 3. For example, the region RE3 is positioned indirectly on the end surface 3e. The region RE3 is closer to the reference plane PL1 than the region RE1.

For example, the second electrode layer E2 of the electrode portion 5a includes the regions RE1 and RE2, and the second electrode layer E2 of the electrode portion 5e includes the region RE3. For example, the region RE1 may include the first region, and the region RE2 may include the second region. For example, the region RE1 may include the first region, and the region RE3 may include the second region.

The first electrode layer E1 is formed through sintering electrically conductive paste applied onto the surface of the element body 3. The electrically conductive paste is applied onto the partial regions of the side surfaces 3a, the end surface 3e, and the first ridge portions. The first electrode layer E1 is formed to cover the partial region of each of the four side surfaces 3a, the end surface 3e, and the first ridge portions. The first electrode layer E1 is formed through sintering a metal component (metal particles) included in the electrically conductive paste. The first electrode layer E1 includes a sintered metal layer. The first electrode layer E1 includes the sintered metal layer formed on the element body 3. For example, the first electrode layer E1 includes a sintered metal layer made of copper. The first electrode layer E1 may include a sintered metal layer made of nickel. The first electrode layer E1 may include a base metal. For example, the electrically conductive paste may include particles made of copper or nickel, a glass component, an organic binder, and an organic solvent. For example, the first electrode layers E1 included in the electrode portions 5a and 5e are formed integrally with each other.

The second electrode layer E2 is formed through curing electrically conductive resin paste applied onto the first electrode layer E1. The electrically conductive resin paste is applied onto the first electrode layer E1 and the partial regions of the side surfaces 3a. The second electrode layer E2 is formed on both the first electrode layer E1 and the element body 3. For example, the electrically conductive resin paste includes a plurality of electrically conductive particles, a resin, and an organic solvent. For example, the resin may include a thermosetting resin. For example, the thermosetting resin may include a phenol resin, an acrylic resin, a silicone resin, an epoxy resin, or a polyimide resin. The second electrode layer E2 is in contact with a part of the second ridge portion. For example, the second electrode layers E2 included in the electrode portions 5a and 5e are integrally formed with each other.

As illustrated in FIGS. 5 to 7, the second electrode layer E2 includes a plurality of electrically conductive particles 11 and a resin 21. The plurality of electrically conductive particles 11 form an electrically conductive path in the second electrode layer E2. The second electrode layer E2 includes a conductive resin layer. The plurality of electrically conductive particles 11 include a plurality of electrically conductive particles 13, a plurality of electrically conductive particles 15, and a plurality of electrically conductive particles 17. FIGS. 5 to 7 schematically illustrate the cross-sectional configuration of the second electrode layer E2. The shape and size of the electrically conductive particles 11 (electrically conductive particles 13, 15, and 17) illustrated in FIGS. 5 to 7 may be different from the shape and size of the actual electrically conductive particles. In FIGS. 5 to 7, hatching indicating a cross section is omitted.

As illustrated in FIG. 8, the electrically conductive particles 13 include a core 13a and a film 13b covering the core 13a. The core 13a is less prone to migration than silver. For example, the core 13a is made of resin. That is, the core 13a includes a resin, for example. The resin included in the core 13a has heat resistance. For example, the resin included in the core 13a includes an acrylic resin, a styrene resin, a phenol resin, a silicone resin, a melamine resin, a fluorine resin, a polyamide resin, a polyimide resin, a silicone rubber, a fluorine rubber, or a copolymer thereof. The film 13b is made of silver. That is, the film 13b includes silver. For example, the film 13b is in contact with the core 13a. For example, the film 13b directly covers the core 13a. For example, a thickness of the film 13b ranges from 50 to 700 nm. The film 13b includes the outermost layer of the electrically conductive particles 13. The electrically conductive particle 13 includes a surface on which the film 13b is exposed. The electrically conductive particles 13 adjacent to each other are electrically conducted to each other through contact or close proximity between the films 13b of the adjacent electrically conductive particles 13. For example, the electrically conductive particle 13 has a spherical-shape. A particle diameter of the electrically conductive particle 13 ranges from 0.5 to 10 μm. For example, the particle diameter of the electrically conductive particles 13 is defined as an average particle diameter of the electrically conductive particles 13. For example, the average particle diameter of the electrically conductive particles 13 is 2 μm.

The electrically conductive particle 15 is made of silver. That is, the electrically conductive particle 15 includes silver. For example, the electrically conductive particle 15 has a flake-shape. A particle diameter of the electrically conductive particle 15 ranges from 2 to 10 μm. For example, the particle diameter of the electrically conductive particles 15 is defined as an average particle diameter of the electrically conductive particles 15. For example, the average particle diameter of the electrically conductive particles 15 is 5 μm.

The electrically conductive particle 17 is made of silver. That is, the electrically conductive particle 17 includes silver. For example, the electrically conductive particle 17 has a spherical-shape. A particle diameter of the electrically conductive particle 17 ranges from 1 to 5 μm. For example, the particle diameter of the electrically conductive particles 17 is defined as an average particle diameter of the electrically conductive particles 17. For example, the average particle diameter of the electrically conductive particles 17 is 3 μm.

For example, the particle diameter of the electrically conductive particles 17 is smaller than the particle diameter of the electrically conductive particles 15. For example, the particle diameter of the electrically conductive particle 13 is smaller than the particle diameters of the electrically conductive particles 15 and 17. For example, the electrically conductive particles 13 may include first electrically conductive particles, and the electrically conductive particles 15 may include second electrically conductive particles. For example, the electrically conductive particles 13 may include first electrically conductive particles, and the electrically conductive particles 17 may include second electrically conductive particles. The particle diameter of the electrically conductive particles 11 may be defined as an equivalent circle diameter.

The above-described “spherical-shape” may include a shape that is not a true spherical shape. For example, the spherical-shape may include a shape having a major axis and a minor axis having different lengths from each other. For example, the difference in length between the major axis and the minor axis may be 50% or less of the length of the major axis.

The above-described “flake-shape” includes a shape having a major axis and a minor axis having different lengths from each other. A ratio of the length of the minor axis to the length of the major axis (the length of the minor axis the length of the major axis) may be ⅕ or less, for example.

The electrically conductive particles 13, 15, and 17 may have a smooth surface or a rough surface.

As illustrated in FIGS. 5 to 7, a ratio of the electrically conductive particles 13 to a total of the electrically conductive particles 13 and the electrically conductive particles 15 in the region RE1 is larger than a ratio of the electrically conductive particles 13 to a total of the electrically conductive particles 13 and the electrically conductive particles 15 in the region RE2. A ratio of the electrically conductive particles 13 to a total of the electrically conductive particles 13 and the electrically conductive particles 15 in the region RE1 is larger than a ratio of the electrically conductive particles 13 to a total of the electrically conductive particles 13 and the electrically conductive particles 15 in the region RE3. A ratio of the electrically conductive particles 13 to a total of the electrically conductive particles 13 and the electrically conductive particles 15 and 17 in the region RE1 is larger than a ratio of the electrically conductive particles 13 to a total of the electrically conductive particles 13 and the electrically conductive particles 15 and 17 in the region RE2. A ratio of the electrically conductive particles 13 to a total of the electrically conductive particles 13 and the electrically conductive particles 15 and 17 in the region RE1 is larger than a ratio of the electrically conductive particles 13 to a total of the electrically conductive particles 13 and the electrically conductive particles 15 and 17 in the region RE3.

As illustrated in FIG. 5, in the region RE1, the ratio of the electrically conductive particles 13 to the total of the electrically conductive particles 13 and the electrically conductive particles 15 is larger than a ratio of the electrically conductive particles 15 to the total of the electrically conductive particles 13 and the electrically conductive particles 15. In the region RE1, the ratio of the electrically conductive particles 13 to the total of the electrically conductive particles 13 and the electrically conductive particles 15 and 17 is larger than a ratio of the electrically conductive particles 15 to the total of the electrically conductive particles 13 and the electrically conductive particles 15 and 17.

For example, each ratio described above can be obtained as follows.

A cross-sectional photograph of the external electrode 5 including the second electrode layer E2 is acquired. For example, the cross-sectional photograph is a photograph of a cross-section of the external electrode 5, the photograph being obtained through cutting the external electrode 5 along a plane perpendicular to both the end surface 3e and the pair of side surfaces 3a. For example, this cross-sectional photograph is a photograph of the cross-section of the external electrode 5 when the external electrode 5 is cut along a plane parallel to the second pair of side surfaces 3a and equidistant from the second pair of side surfaces 3a. For example, the cross-sectional photograph is a scanning electron microscope (SEM) photograph. Image processing of the acquired cross-sectional photograph is performed using software. Based on the results of this image processing, boundaries of the electrically conductive particles 13, 15, and 17 are determined, and the total area of each of the electrically conductive particles 13, 15, and 17 in the cross-sectional photograph is obtained for each of the regions RE1, RE2, and RE3.

In each of the regions RE1, RE2, and RE3, the total area of the electrically conductive particles 13 is divided by the sum of the total area of the electrically conductive particles 13 and the total area of the electrically conductive particles 15. In each of the regions RE1, RE2, and RE3, the total area of the electrically conductive particles 13 is divided by the sum of the total area of the electrically conductive particles 13, the total area of the electrically conductive particles 15, and the total area of the electrically conductive particles 17. In each of the regions RE1, RE2, and RE3, the total area of the electrically conductive particles 15 is divided by the sum of the total area of the electrically conductive particles 13 and the total area of the electrically conductive particles 15. In each of the regions RE1, RE2, and RE3, the total area of the electrically conductive particles 15 is divided by the sum of the total area of the electrically conductive particles 13, the total area of the electrically conductive particles 15, and the total area of the electrically conductive particles 17. In each of the regions RE1, RE2, and RE3, the total area of the electrically conductive particles 17 is divided by the sum of the total area of the electrically conductive particles 13, the total area of the electrically conductive particles 15, and the total area of the electrically conductive particles 17. Each divided value may be expressed as a percentage. The value expressed as a percentage may be expressed in units of “vol %” as the content of the corresponding electrically conductive particles in the electrically conductive particles 13, 15, and 17.

In the region RE1, the ratio of the electrically conductive particles 13 to the total of the electrically conductive particles 13 and the electrically conductive particles 15 ranges from ⅗to ⅚, for example. In the region RE1, the ratio of the electrically conductive particles 13 to the total of the electrically conductive particles 13 and the electrically conductive particles 15 is ⅘, for example.

In the region RE1, the ratio of the electrically conductive particles 13 to the total of the electrically conductive particles 13 and the electrically conductive particles 15 and 17 ranges from ½ to ⅘, for example. In the region RE1, the ratio of the electrically conductive particles 13 to the total of the electrically conductive particles 13 and the electrically conductive particles 15 and 17 is ¾, for example.

In the region RE2, the ratio of the electrically conductive particles 13 to the total of the electrically conductive particles 13 and the electrically conductive particles 15 ranges from ½ to ⅘, for example. In the region RE2, the ratio of the electrically conductive particles 13 to the total of the electrically conductive particles 13 and the electrically conductive particles 15 is ⅗, for example.

In the region RE2, the ratio of the electrically conductive particles 13 to the total of the electrically conductive particles 13 and the electrically conductive particles 15 and 17 ranges from 4/9 to ¾, for example. In the region RE2, the ratio of the electrically conductive particles 13 to the total of the electrically conductive particles 13 and the electrically conductive particles 15 and 17 is ½, for example.

In the region RE3, the ratio of the electrically conductive particles 13 to the total of the electrically conductive particles 13 and the electrically conductive particles 15 ranges from ⅜ to ⅗, for example. In the region RE3, the ratio of the electrically conductive particles 13 to the total of the electrically conductive particles 13 and the electrically conductive particles 15 is ½, for example.

In the region RE3, the ratio of the electrically conductive particles 13 to the total of the electrically conductive particles 13 and the electrically conductive particles 15 and 17 ranges from 2/7 to ½, for example. In the region RE3, the ratio of the electrically conductive particles 13 to the total of the electrically conductive particles 13 and the electrically conductive particles 15 and 17 is 4/9, for example.

In the region RE1, the ratio of the electrically conductive particles 15 to the total of the electrically conductive particles 13 and the electrically conductive particles 15 ranges from ⅙ to ⅖, for example. In the region RE1, the ratio of the electrically conductive particles 15 to the total of the electrically conductive particles 13 and the electrically conductive particles 15 is ⅕, for example.

In the region RE1, the ratio of the electrically conductive particles 15 to the total of the electrically conductive particles 13 and the electrically conductive particles 15 and 17 ranges from 1/7 to ⅓, for example. In the region RE1, the ratio of the electrically conductive particles 15 to the total of the electrically conductive particles 13 and the electrically conductive particles 15 and 17 is ⅙, for example.

In the region RE2, the ratio of the electrically conductive particles 15 to the total of the electrically conductive particles 13 and the electrically conductive particles 15 ranges from ⅕ to ½, for example. In the region RE2, the ratio of the electrically conductive particles 15 to the total of the electrically conductive particles 13 and the electrically conductive particles 15 is ⅖, for example.

In the region RE2, the ratio of the electrically conductive particles 15 to the total of the electrically conductive particles 13 and the electrically conductive particles 15 and 17 ranges from ⅙ to ⅖, for example. In the region RE2, the ratio of the electrically conductive particles 15 to the total of the electrically conductive particles 13 and the electrically conductive particles 15 and 17 is ⅓, for example.

In the region RE3, the ratio of the electrically conductive particles 15 to the total of the electrically conductive particles 13 and the electrically conductive particles 15 ranges from ⅖ to ⅝, for example. In the region RE3, the ratio of the electrically conductive particles 15 to the total of the electrically conductive particles 13 and the electrically conductive particles 15 is ½, for example.

In the region RE3, the ratio of the electrically conductive particles 15 to the total of the electrically conductive particles 13 and the electrically conductive particles 15 and 17 ranges from ⅓ to ½ for example. In the region RE3, the ratio of the electrically conductive particles 15 to the total of the electrically conductive particles 13 and the electrically conductive particles 15 and 17 is ⅖, for example.

In the region RE1, the ratio of the electrically conductive particles 17 to the total of the electrically conductive particles 13 and the electrically conductive particles 15 and 17 ranges from 1/20 to 1/7, for example. In the region RE1, the ratio of the electrically conductive particles 17 to the total of the electrically conductive particles 13 and the electrically conductive particles 15 and 17 is 3/40, for example.

In the region RE2, the ratio of the electrically conductive particles 17 to the total of the electrically conductive particles 13 and the electrically conductive particles 15 and 17 ranges from 3/40 to ⅙, for example. In the region RE2, the ratio of the electrically conductive particles 17 to the total of the electrically conductive particles 13 and the electrically conductive particles 15 and 17 is 1/7, for example.

In the region RE3, the ratio of the electrically conductive particles 17 to the total of the electrically conductive particles 13 and the electrically conductive particles 15 and 17 ranges from 1/7 to ⅕, for example. In the region RE3, the ratio of the electrically conductive particles 17 to the total of the electrically conductive particles 13 and the electrically conductive particles 15 and 17 is ⅙, for example.

The particle diameters of the electrically conductive particles 13, 15, and 17 may be obtained based on the cross-sectional photograph described above.

The particle diameter may be calculated from the area of each of the electrically conductive particles 13, 15, and 17 for all of the electrically conductive particles 13, 15, and 17 included in the cross-sectional photograph for calculating the particle diameter converted into the equivalent circle diameter. The particle diameter may be calculated for an arbitrary number of electrically conductive particles 13, 15, and 17 among the electrically conductive particles 13, 15, and 17 included in the cross-sectional photograph. The arbitrary number may be 100, for example. The average value of the obtained particle diameters is regarded as the average particle diameter.

For example, the above-mentioned ratios are controlled through preparing a plurality of electrically conductive resin pastes having different mixing ratios of the electrically conductive particles 13, 15, and 17, and through selectively using the conductive resin paste to be applied for each of the regions RE1, RE2, and RE3.

For example, the above-mentioned ratios can be controlled through adjusting rheological characteristics of the electrically conductive resin paste to be prepared. For example, when the electrically conductive resin paste is applied to the element body 3 through a dipping process, the amount of movement of the electrically conductive particles 13, 15, and 17 within the electrically conductive resin paste between the time when the electrically conductive resin paste is applied and the time when the electrically conductive resin paste is cured can be controlled depending on the rheological properties, due to the differences in size or mass of the electrically conductive particles 13, 15, and 17. For example, the electrically conductive particles 13 is less prone to move than the electrically conductive particles 15 and 17. Through adjusting the amount of movement of the electrically conductive particles 13, 15, and 17, the above-mentioned ratios are controlled.

The third electrode layer E3 is formed on the second electrode layer E2 through a plating process. For example, the third electrode layer E3 includes a metal plating layer. The third electrode layer E3 may include a nickel plating layer. The third electrode layer E3 may include nickel. The nickel plating layer tends to have better solder leach resistance than the electrically conductive particle 13 included in the second electrode layer E2. The third electrode layer E3 covers the second electrode layer E2.

The fourth electrode layer E4 is formed on the third electrode layer E3 through a plating process. For example, the fourth electrode layer E4 includes a metal plating layer. The fourth electrode layer E4 may include a solder plating layer. The solder plating layer may include a tin (Sn) plating layer. The fourth electrode layer E4 may include tin. The fourth electrode layer E4 may include a tin-silver alloy (Sn—Ag) plating layer, a tin-bismuth alloy (Sn—Bi) plating layer, or a tin-copper alloy (Sn—Cu) plating layer. The fourth electrode layer E4 covers the third electrode layer E3.

The third electrode layer E3 and the fourth electrode layer E4 are included in a plating layer E_{PL} formed on the second electrode layer E2. That is, the external electrode 5 includes the plating layer E_{PL}, and the plating layer E_{PL} includes the third electrode layer E3 and the fourth electrode layer E4. The plating layer E_{PL} covers the second electrode layer E2. For example, the third electrode layers E3 included in the electrode portions 5a and 5e are formed integrally with each other. For example, the fourth electrode layers E4 included in the electrode portions 5a and 5e are formed integrally with each other. The plating layer E_{PL} may include another plating layer between the second electrode layer E2 and the third electrode layer E3. The plating layer E_{PL} may include another plating layer between the third electrode layer E3 and the fourth electrode layer E4. The plating layer E_{PL} may be a single layer.

The plating layer E_{PL} covering the second electrode layer E2 tends to adhere to the second electrode layer E2, but does not tend to adhere to the element body 3. Therefore, the plating layer E_{PL} is separated from the element body 3 by a gap. That is, the plating layer E_{PL} has the gap between the plating layer E_{PL} and the element body 3. The third electrode layer E3 is separated from the side surface 3a by a gap G_{E3}. That is, the third electrode layer E3 has the gap G_{E3} between the third electrode layer E3 and the element body 3. The gap G_{E3} is formed between an end of the third electrode layer E3 and the side surface 3a. The fourth electrode layer E4 is separated from the side surface 3a by a gap G_{E4}. That is, the fourth electrode layer E4 has the gap G_{E4} between the fourth electrode layer E4 and the element body 3. The gap G_{E4} is formed between an end of the fourth electrode layer E4 and the side surface 3a. Each of the third electrode layer E3 and the fourth electrode layer E4 is separated from the second ridge portion by a gap. That is, each of the third electrode layer E3 and the fourth electrode layer E4 has the gap between the second ridge portion and each of the third electrode layer E3 and the fourth electrode layer E4. For example, widths of the gaps G_{E3} and G_{E4} are larger than 0 and equal to or less than 3 μm. For example, the widths of the gaps G_{E3} and G_{E4} are larger than 0 and less than 2μm. For example, widths of the gaps between the third electrode layer E3 and the second ridge portion, as well as between the fourth electrode layer E4 and the second ridge portion, are larger than 0 and equal to or less than 3 μm. For example, the widths of the gaps between the third electrode layer E3 and the second ridge portion, as well as between the fourth electrode layer E4 and the second ridge portion, is larger than 0 and less than 2 μm. The width of the gap G_{E3} may be different from the width of the gap G_{E4}. The widths of the gaps G_{E3} and G_{E4} may be different from the widths of the gaps between the third electrode layer E3 and the second ridge portion, as well as between the fourth electrode layer E4 and the second ridge portion. In a configuration in which the width of the gap G_{E3} is different from the width of the gap G_{E4}, the width of the gap of the plating layer E_{PL} may be defined as the smaller value of the width of the gap G_{E3} or the width of the gap G_{E4}.

For example, the widths of the gaps G_{E3} and G_{E4} are smaller than the particle diameter of the electrically conductive particle 13.

In the multilayer capacitor C1, the electrically conductive particle 13 includes the core 13a that is less prone to migration than silver. The electrically conductive particle 13 has a lower silver content than the electrically conductive particle made of silver and having the same size as the electrically conductive particle 13. The second electrode layer E2 including the plurality of electrically conductive particles 13 and the plurality of electrically conductive particles 15 and 17 tends to have a lower silver content than the second electrode layer E2 including only the plurality of electrically conductive particles 15 and 17, i.e., the second electrode layer E2 not including the electrically conductive particles 13. Even in environments where silver migration may occur, a configuration with a low silver content reduces the rate at which silver migration progresses. Therefore, the multilayer capacitor C1 suppresses the progression of silver migration.

The resin tends to absorb moisture. When the multilayer capacitor C1 is solder-mounted on an electronic device, the moisture absorbed by the resin may be gasified so that volume expansion may occur. In this case, stress may act on the second electrode layer E2, and as a result, the second electrode layer E2 may peel off. For example, the electronic device includes a circuit board or an electronic component.

In the multilayer capacitor C1, the plating layer E_{PL} is separated from the element body 3 by the gaps G_{E3} and G_{E4}. Even if moisture absorbed by the resin is gasified when the multilayer capacitor C1 is solder-mounted, a gas generated from the moisture moves to the outside of the external electrode 5 through the gaps G_{E3} and G_{E4}. Therefore, stress tends not to act on the second electrode layer E2. Consequently, the multilayer capacitor C1 suppresses the peeling off of the second electrode layer E2.

In the multilayer capacitor C1, the ratio of the electrically conductive particles 13 to the total of the electrically conductive particles 13 and the electrically conductive particles 15 and 17 in the region RE1 may be larger than the ratio of the electrically conductive particles 13 to the total of the electrically conductive particles 13 and the electrically conductive particles 15 and 17 in each of the regions RE2 and RE3.

Silver ion tends to migrate from the end edge E2e of the second electrode layer E2. In a configuration in which the region RE1 including the end edge E2e has the above-described “ratio of the electrically conductive particles 13” that is larger than the above-described “ratio of the electrically conductive particles 13” of each of the regions RE2 and RE3, the region RE1 tends to have a low silver content. This configuration reliably reduces the rate at which the silver migration progresses. Therefore, this configuration reliably suppresses the progression of silver migration.

Each of the regions RE2 and RE3 has the above-described “ratio of the electrically conductive particles 13” that is smaller than the above-described “ratio of the electrically conductive particles 13” of the region RE1. Therefore, the regions RE2 and RE3 tend to have a high silver content. Silver has a high electrical conductivity. the regions RE2 and RE3 reliably maintain electrical conductivity in the second electrode layer E2. This configuration suppresses an increase in ESR of the multilayer capacitor C1.

In the environments where silver migration may occur, silver included in the region RE1 is ionized, and silver ions move from the region RE1 to the outside of the external electrode 5. In this case, silver included in the electrically conductive particles 11 near the end edge E2e, among the electrically conductive particles 11 included in the region RE1, tends to be ionized. In the electrically conductive particles 13, when silver included in the film 13b is ionized and generated silver ions move, the core 13a remains. As described above, the core 13a is less prone to migration than silver. As silver migration progresses, a larger amount of the core 13a remains in the region of the region RE1 that is closer to the end edge E2e. The core 13a remaining in the region closer to the end edge E2e tends to impede the silver ions from migrating from the region of the region RE1 that is farther from the end edge E2e. Therefore, the multilayer capacitor C1 can further suppress the progression of silver migration.

In the multilayer capacitor C1, the element body 3 may include the end surface 3e and the side surface 3a that are adjacent to each other. The second electrode layer E2 may be disposed on both the end surface 3e and the side surface 3a. The region RE1 may be positioned on the side surface 3a and the region RE3 may be positioned on the end surface 3e.

In the multilayer capacitor C1, for example, the internal electrode 7 is exposed at the end surface 3e. A configuration in which the region RE3 is positioned on the end surface 3e reliably maintains electrical conductivity in the second electrode layer E2 of the electrode portion 5e. Therefore, this configuration reliably suppresses an increase in the ESR of the multilayer capacitor C1.

In the multilayer capacitor C1, the element body 3 may include the end surface 3e and the side surface 3a that are adjacent to each other. The second electrode layer E2 may be disposed on the side surface 3a. The region RE2 may be positioned closer to the reference plane PL1 than the region RE1.

In the multilayer capacitor C1, for example, the internal electrode 7 is exposed at the end surface 3e. In a configuration in which the region RE2 is positioned closer to the reference plane PL1 than the region RE1, this configuration reliably maintains electrical conductivity in the vicinity of the second electrode layer E2 of the electrode portion 5e. Therefore, this configuration can reliably suppress an increase in the ESR of the multilayer capacitor C1.

In the multilayer capacitor C1, the external electrode 5 may include the first electrode layer E1. The region RE1 may be positioned directly on the element body 3, and the region RE2 or the region RE3 may be positioned directly on the first electrode layer E1.

In a configuration in which the region RE2 or the region RE3 is positioned directly on the first electrode layer E1, this configuration tends to reduce electrical resistance in the electrically conductive path between the plating layer E_{PL} and the first electrode layer E1. Therefore, this configuration reliably suppresses an increase in the ESR of the multilayer capacitor C1.

In the multilayer capacitor C1, the particle diameter of the electrically conductive particle 13 may be smaller than the particle diameter of the electrically conductive particle 15.

In a configuration in which the electrically conductive particle 13 has the particle diameter that is smaller than the particle diameter of the electrically conductive particle 15, this configuration can increase the content of the electrically conductive particle 13 in the region RE1. Therefore, this configuration can further suppress the progression of silver migration.

In the multilayer capacitor C1, the plurality of electrically conductive particles 11 may include the plurality of electrically conductive particles 15.

In a configuration in which the electrically conductive particle 15 is flake-shaped, this configuration further suppresses an increase in the ESR of the multilayer capacitor C1.

In the multilayer capacitor C1, in the region RE1, the ratio of the electrically conductive particles 13 to the total of the electrically conductive particles 13 and the electrically conductive particles 15 may be larger than the ratio of the electrically conductive particles 15 to the total of the electrically conductive particles 13 and the electrically conductive particles 15.

In a configuration in which the above-described “ratio of the electrically conductive particles 13” is larger than the above-described “ratio of the electrically conductive particles 15” in the region RE1, this configuration can increase the content of the electrically conductive particle 13 in the region RE1. Therefore, this configuration can further suppress the progression of silver migration.

In the multilayer capacitor C1, the plurality of electrically conductive particles 11 may include the plurality of electrically conductive particles 17.

In a configuration in which the plurality of electrically conductive particles 11 includes the plurality of electrically conductive particles 17, this configuration can increase the content of the electrically conductive particle 11 in the region RE2 or the region RE3. Therefore, this configuration can reliably suppress an increase in the ESR of the multilayer capacitor C1.

In the multilayer capacitor C1, the particle diameter of the electrically conductive particle 17 may be smaller than the particle diameter of the electrically conductive particle 15, and the particle diameter of the electrically conductive particle 13 may be smaller than the particle diameter of the electrically conductive particle 17.

In a configuration in which the electrically conductive particle 13 has the particle diameter that is smaller than the particle diameters of the electrically conductive particle 15 and 17, this configuration can increase the content of the electrically conductive particle 13 in the region RE1. Therefore, this configuration can further suppress the progression of silver migration.

In a configuration in which the particle diameter of the electrically conductive particle 17 is smaller than the particle diameter of the electrically conductive particle 15, this configuration can increase the content of the electrically conductive particle 11 in the region RE2 or the region RE3. Therefore, this configuration can reliably suppress an increase in the ESR of the multilayer capacitor C1.

In the multilayer capacitor C1, the widths of the gaps G_{E3} and G_{E4} may be smaller than the particle diameter of the electrically conductive particle 13.

In a configuration in which the widths of the gaps G_{E3} and G_{E4} are smaller than the particle diameter of the electrically conductive particle 13, this configuration suppresses the progression of silver migration from the end edge of the second electrode layer E2. Therefore, this configuration further suppresses the progression of silver migration.

In the multilayer capacitor C1, the core 13a may include the resin.

The resin tends not to oxidize. Therefore, a configuration in which the core 13a includes the resin suppresses deterioration of characteristics of the electrically conductive particle 13. For example, the characteristics of the electrically conductive particle 13 include electrical conductivity or heat resistance.

For example, the second electrode layer E2 is formed through curing the electrically conductive resin paste. For example, the electrically conductive resin paste includes the thermosetting resin and the organic solvent. The organic solvent is vaporized. The vaporization of the organic solvent generates gas within the conductive resin paste. The gas generated by the vaporization of the organic solvent directly reaches the surface of the electrically conductive resin paste from any portion within the electrically conductive resin paste where the organic solvent is present, and moves out from the electrically conductive resin paste. When the gas generated by the vaporization of the organic solvent moves within the electrically conductive resin paste, the flake-shaped electrically conductive particles tend to impede the gas from moving within the electrically conductive resin paste. Therefore, the second electrode layer E2 tends to include a plurality of voids.

In a configuration in which the plurality of electrically conductive particles 11 includes the plurality of electrically conductive particles 13, the content of the electrically conductive particles 15 tends to be smaller than in a configuration in which the plurality of electrically conductive particles 11 does not include the plurality of electrically conductive particles 13. Therefore, the configuration in which the plurality of electrically conductive particles 11 includes the plurality of electrically conductive particles 13 tends to suppress the obstruction of the movement of the gas generated by the vaporization of the organic solvent.

A configuration in which the electrically conductive particle 13 has the particle diameters smaller than the particle diameters of the electrically conductive particles 15 and 17 can increase the content of the electrically conductive particles 13 in the second electrode layer E2. This configuration can increase the content of the electrically conductive particles 11 in the second electrode layer E2.

Consequently, the second electrode layer E2 tends not to include the plurality of voids.

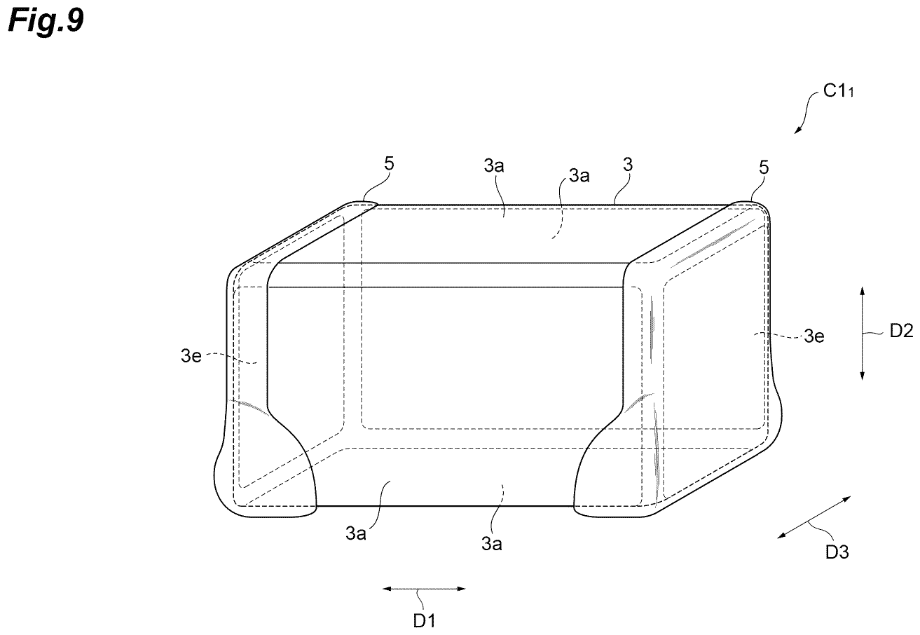

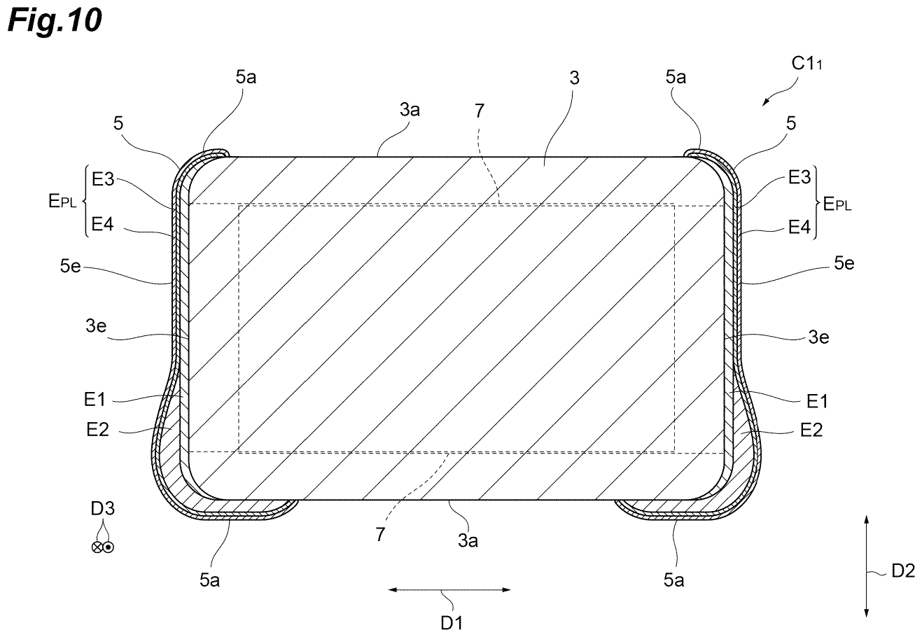

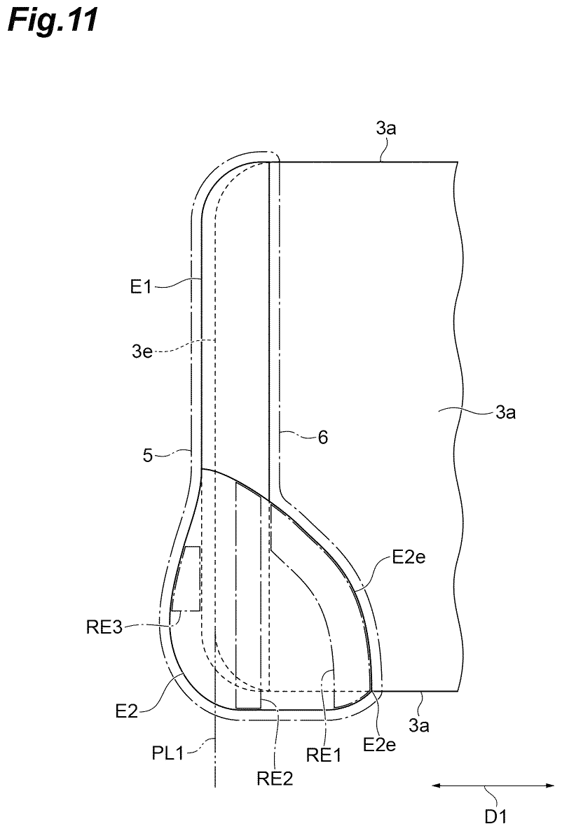

A Configuration of a multilayer capacitor C1₁ according to a modified example of the present example will be described with reference to FIGS. 9 to 11. FIG. 9 is a perspective view of a multilayer capacitor according to the modified example. FIG. 10 is a view illustrating a cross-sectional configuration of the multilayer capacitor according to the modified example. FIG. 11 is a view illustrating a second electrode layer.

The multilayer capacitor C1₁ is generally similar to or the same as the multilayer capacitor C1 described above. However, the multilayer capacitor C1₁ is different from the multilayer capacitor C1 in a configuration of the external electrode 5. Hereinafter, differences between the multilayer capacitor C1₁ and the multilayer capacitor C1 will be mainly described.

For example, an electronic component includes the multilayer capacitor C1₁.

For example, the multilayer capacitor C1₁ is disposed in such a manner that one side surface 3a of the first pair of side surfaces 3a is arranged to constitute a mounting surface. The above-described one side surface 3a includes the mounting surface. In the multilayer capacitor C1₁, for example, the plurality of internal electrodes 7 are disposed in different positions (layers) in the direction D3.

The electrode portion 5a positioned on the side surface 3a that opposes the side surface 3a arranged to constitute the mounting surface includes the first electrode layer E1, the third electrode layer E3, and the fourth electrode layer E4, and does not include the second electrode layer E2. In the electrode portion 5a positioned on the side surface 3a that opposes the side surface 3a arranged to constitute the mounting surface, the plating layer E_{PL} directly covers the first electrode layer E1. The side surface 3a that opposes the side surface 3a arranged to constitute the mounting surface is not covered with the second electrode layer E2 and is exposed from the second electrode layer E2.

The second electrode layer E2 of the electrode portion 5a positioned on each of the second pair of side surfaces 3a covers only a partial region of the ridge portion between the end surface 3e and each of the second pair of side surfaces 3a, and only a partial region of each of the second pair of side surfaces 3a. For example, the partial region of the ridge portion between the end surface 3e and each of the second pair of side surfaces 3a is positioned closer to the side surface 3a arranged to constitute the mounting surface. For example, the partial region of each of the second pair of side surfaces 3a is positioned closer to a corner closer to the side surface 3a arranged to constitute the mounting surface and the end surface 3e.

The electrode portion 5a positioned on each of the second pair of side surfaces 3a may have the following configuration. The second electrode layer E2 of the electrode portion 5a positioned on each of the second pair of side surfaces 3a indirectly covers the partial region of the ridge portion between the end surface 3e and each of the second pair of side surfaces 3a, in such a manner that the first electrode layer E1 is positioned between the second electrode layer E2 and the ridge portion between the end surface 3e and each of the second pair of side surfaces 3a. The second electrode layer E2 of the electrode portion 5a positioned on each of the second pair of side surfaces 3a directly covers the partial region of each of the second pair of side surfaces 3a. The second electrode layer E2 of the electrode portion 5a positioned on each of the second pair of side surfaces 3a directly covers a partial region of a portion, of the first electrode layer E1, positioned on the ridge portion between the end surface 3e and each of the second pair of side surfaces 3a. The electrode portion 5a positioned on each of the second pair of side surfaces 3a includes a region in which the first electrode layer E1 is exposed from the second electrode layer E2 and a region in which the first electrode layer E1 is covered with the second electrode layer E2.

The second electrode layer E2 of the electrode portion 5e covers only a partial region of the end surface 3e. For example, the partial region of the end surface 3e is positioned closer to the side surface 3a arranged to constitute the mounting surface.

The electrode portion 5e may have the following configuration. The second electrode layer E2 of the electrode portion 5e indirectly covers the partial region of the end surface 3e, in such a manner that the first electrode layer E1 is positioned between the second electrode layer E2 and the end surface 3e. The second electrode layer E2 of the electrode portion 5e directly covers only a partial region of the portion, of the first electrode layer E1, positioned on the end surface 3e. The electrode portion 5e includes a region where the first electrode layer E1 is exposed from the second electrode layer E2, and a region where the first electrode layer E1 is covered with the second electrode layer E2.

In the multilayer capacitor C1₁, the second electrode layer E2 continuously covers only a part of the side surface 3a arranged to constitute the mounting surface, only a part of the end surface 3e, and only a part of each of the second pair of side surfaces 3a. The second electrode layer E2 includes a portion continuously covering only a part of the side surface 3a arranged to constitute the mounting surface, only a part of the end surface 3e, and only a part of each of the second pair of side surfaces 3a. A part of the first electrode layer E1 is exposed from the second electrode layer E2.

As illustrated in FIG. 11, for example, the second electrode layer E2 of the electrode portion 5a positioned on the side surface 3a arranged to constitute the mounting surface includes the region RE1. The second electrode layer E2 of the electrode portion 5a positioned on the side surface 3a arranged to constitute the mounting surface may include the region RE2. For example, the second electrode layer E2 of the electrode portion 5a positioned on each of the second pair of side surfaces 3a includes the region RE1. The second electrode layer E2 of the electrode portion 5a positioned on each of the second pair of side surfaces 3a may include the region RE2. For example, the second electrode layer E2 of the electrode portion 5e includes the region RE3.

In the multilayer capacitor C1₁, like the multilayer capacitor C1, the second electrode layer E2 tends to have a low silver content. Therefore, the multilayer capacitor C1₁ suppresses the progression of silver migration.

In the multilayer capacitor C1₁, like the multilayer capacitor C1, the third electrode layer E3 is separated from the side surface 3a by the gap G_{E3}, and the fourth electrode layer E4 is separated from the side surface by the gap G_{E4}. That is, in the multilayer capacitor C1₁, the third electrode layer E3 has the G_{E3} between the third electrode layer E3 and the side surface 3a, and the fourth electrode layer E4 has the G_{E4} between the fourth electrode layer E4 and the side surface 3a. Even if moisture absorbed by the resin is gasified, a gas generated from the moisture moves to the outside of the external electrode 5 through the gaps G_{E3} and G_{E4}. Therefore, the multilayer capacitor C1₁ suppresses the peeling off of the second electrode layer E2.

In the present specification, when an element is described as being disposed on another element, the element may be directly disposed on the other element or be indirectly disposed on the other element. When an element is indirectly disposed on another element, an intervening element is present between the element and the other element. When an element is directly disposed on another element, no intervening element is present between the element and the other element.

In the present specification, when an element is described as being positioned on another element, the element may be directly positioned on the other element or be indirectly positioned on the other element. When an element is indirectly positioned on another element, an intervening element is present between the element and the other element. When an element is directly positioned on another element, no intervening element is present between the element and the other element.

In the present specification, when an element is described as covering another element, the element may directly cover the other element or indirectly cover the other element. When an element indirectly covers another element, an intervening element is present between the element and the other element. When an element directly covers another element, no intervening element is present between the element and the other element.

It is to be understood that not all aspects, advantages and features described herein may necessarily be achieved by, or included in, any one particular example. Indeed, having described and illustrated various examples herein, it should be apparent that other examples may be modified in arrangement and detail.

The particle diameter of the electrically conductive particle 13 may not be smaller than the particle diameters of the electrically conductive particles 15 and 17. The configuration in which the particle diameter of the electrically conductive particle 13 is smaller than the particle diameters of the electrically conductive particles 15 and 17 can at least further suppress the progression of silver migration, as described above.

The plurality of electrically conductive particles 11 may not include the electrically conductive particles 17. The configuration in which the plurality of electrically conductive particles 11 include the plurality of electrically conductive particles 17 can reliably suppress an increase in the ESR, as described above.

The core 13a may not include the resin. The configuration in which the core 13a includes the resin suppresses the deterioration of characteristics of the electrically conductive particles 13, as described above.

In the present example and modified example, the electronic component includes the multilayer capacitor. However, applicable electronic component is not limited to the multilayer capacitor. For example, the applicable electronic component includes a multilayer electronic component such as a multilayer inductor, a multilayer varistor, a multilayer piezoelectric actuator, a multilayer thermistor, a multilayer solid-state battery component, or a multilayer composite component, or electronic components other than the multilayer electronic components.

What is claimed is:

1. An electronic component comprising:
an element body; and
an external electrode disposed on the element body, and including a conductive resin layer that includes a plurality of electrically conductive particles and a resin and a plating layer that is disposed on the conductive resin layer,
wherein the plurality of electrically conductive particles includes:
a plurality of first electrically conductive particles each including a core that is less prone to migration than silver and a film that covers the core and includes silver; and
a plurality of second electrically conductive particles including silver, and
the plating layer is separated from the element body by a gap.

2. The electronic component according to claim 1, wherein
the conductive resin layer includes a first region including an end edge of the conductive resin layer and a second region away from the first region, and
a ratio of the first electrically conductive particles to a total of the first electrically conductive particles and the second electrically conductive particles in the first region is larger than a ratio of the first electrically conductive particles to the total of the first electrically conductive particles and the second electrically conductive particles in the second region.

3. The electronic component according to claim 2, wherein
the element body includes an end surface and a side surface adjacent to each other,
the conductive resin layer is disposed on both the end surface and the side surface, and
the first region is positioned on the side surface and the second region is positioned on the end surface.

4. The electronic component according to claim 2, wherein
the element body includes an end surface and a side surface adjacent to each other,
the conductive resin layer is disposed on the side surface, and
with a plane including the end surface as a reference plane, the second region is positioned closer to the reference plane than the first region.

5. The electronic component according to claim 2, wherein
the external electrode further includes a sintered metal layer that is disposed between the element body and the conductive resin layer and is covered with the conductive resin layer, and
the first region is positioned directly on the element body, and the second region is positioned directly on the sintered metal layer.

6. The electronic component according to claim 1, wherein
a particle diameter of the first electrically conductive particle is smaller than a particle diameter of the second electrically conductive particle.

7. The electronic component according to claim 1, wherein
the plurality of second electrically conductive particles include a plurality of flake-shaped second electrically conductive particles.

8. The electronic component according to claim 7, wherein
the conductive resin layer includes a region including an end edge of the conductive resin layer, and
in the region of the conductive resin layer, a ratio of the first electrically conductive particles to a total of the first electrically conductive particles and the flake-shaped second electrically conductive particles is larger than a ratio of the flake-shaped second electrically conductive particles to a total of the first electrically conductive particles and the flake-shaped second electrically conductive particles.

9. The electronic component according to claim 7, wherein
the plurality of second electrically conductive particles further includes a plurality of spherical-shaped second electrically conductive particles.

10. The electronic component according to claim 9, wherein
a particle diameter of the spherical-shaped second electrically conductive particle is smaller than a particle diameter of the flake-shaped second electrically conductive particle, and a particle diameter of the first electrically conductive particle is smaller than a particle diameter of the spherical-shaped second electrically conductive particle.

11. The electronic component according to claim 1, wherein
a width of the gap is smaller than a particle diameter of the first electrically conductive particle.

12. The electronic component according to claim 1, wherein the core includes a resin.

13. The electronic component according to claim 1, wherein
the plating layer includes a plurality of plating layers, and
each of the plurality of plating layers is separated from the element body by a gap.
